(19) United States
(12) Patent Application Publication
(10) Pub. No.: US 2025/0387878 A1
(43) Pub. Date: Dec. 25, 2025

(54) QUICK CLAMP

(71) Applicant: BIRZMAN CORP., Changhua County (TW)

(72) Inventors: CHUNG-TSUN KUO, Changhua County (TW); CHANG-WEI CHENG, Changhua County (TW); YU-YUAN CHEN, Changhua County (TW)

(21) Appl. No.: 18/752,913

(22) Filed: Jun. 25, 2024

(51) Int. Cl. B25B 5/10; B25B 5/04

(52) U.S. Cl. CPC B25B 5/103; B25B 5/04

(57) ABSTRACT

A quick clamp includes a first clamp part, a second clamp part, a tightening device and a buckle device, the first clamp part has an end fixed to a position and another end having a first clamping part, the second clamp part has an end fixed to a position corresponding to the first clamp part and another end having a second clamping part, the second clamp part can be opened relative to the first clamp part to clamp an object, the tightening device is disposed between the second clamp part and the first clamp part and includes a screw, the buckle device is disposed on the first clamp part and provided for passing the screw and includes a clipping block disposed in the buckle device and distributed on the peripheral side of the screw, and the clipping block is normally engaged with the screw to form one-way engagement positioning.

### TECHNICAL FIELD

The present disclosure relates to a quick clamp, and more particularly relates to a quick clamp that can clamp and release an object easily.

### BACKGROUND OF THE DISCLOSURE

A clamp is provided mainly for the purpose of holding an object in place, and it is not only found in production machinery and equipment, but in fact widely used in many fields to prevent objects from being arbitrarily displaced by force or inertia change (including acceleration or deceleration change), and clamping is one of the most important ways of fixing.

With reference to FIG. 17 for a related-art clamp, the related-art clamp includes a fixed base 91 and a movable clamp 92 pivoted to the fixed base 91, the fixed base 91 has an end with an arm 93 and another end with a fixed clamp 94, the fixed clamp 94 and the movable clamp 92 are relatively separated, so as to form a clamping space between the fixed clamp 94 and the movable clamp 92.

Another related-art clamp further includes a handle 95, a pull rod 96 and a spring 97, a convex part 98 is formed at one end of the handle 95, the pull rod 96 is pivoted on the convex part 98 of the handle 95, a threaded portion is formed at one end of the pull rod 96, and the threaded portion of the pull rod 96 is threaded through the movable clamp 92 and screwed into a fixed base 91. By rotating the handle 95, the convex part 98 can be used to press against the movable clamp 92, so that the movable clamp 92 can be lowered and the distance between the movable clamp 92 and the fixed clamp 94 can be shortened.

Although the related-art clamp can quickly use the eccentric quick-release way to clamp the clamped object, the eccentric quick-release of the clamping space is small. When there is a size difference of the clamped object, it is still necessary to use a screw to make adjustments for the eccentric quick-release and it cannot provide a wide range of applications or achieve a really fast clamping and releasing effects. Obviously, the related-art clamp is poor in practicality, and restrictive and inconvenient in use.

### SUMMARY OF THE DISCLOSURE

It is a primary objective of the present disclosure to provide a quick clamp, including: a first clamp part, with an end combined and fixed to a position and another end having a first clamping part; a second clamp part, with an end combined and fixed to a position corresponding to the first clamp part and another end having a second clamping part, which corresponds to the first clamping part, and can be opened or clamped relative to the first clamp part; a tightening device, comprising a screw and an operating part, the screw passing through the second clamp part and the first clamp part, and the operating part being installed on an outer side of the second clamp part; and a buckle device, installed onto the first clamp part and provided for passing the screw, comprising a cylinder, at least one clipping block, a control rod and a pushback means, and the buckle device has an outer diameter away from the screw; an end of the control rod is provided with at least one tilted buckle slot; the cylinder is sheathed on the control rod; a titled first limit slot is formed on the control rod and at a position corresponding to the cylinder to create a slip space with an increasingly larger outer diameter between the titled buckle slot and the titled first limit slot, an at this time an inclined surface of the buckle slot corresponding to an inclined surface of the first limit slot, and the control rod having a second limit slot configured to be corresponsive to the cylinder second, such that a yield space formed between the buckle slot and the second limit slot has an outer diameter greater than the slip space; wherein the clipping block having a convex clipping tooth disposed on an inner side thereof, the clipping block being disposed at the buckle slot and a peripheral side of the screw, the at least one clipping block is normally situated between the first limit slot and the buckle slot of the cylinder, and the convex clipping tooth is engaged with an outer thread of the screw to form a one-way engagement positioning for limiting the screw to only move in one direction; the pushback means is provided for pushing the screw block normally situated in the slip space towards the screw; when the cylinder and the control rod are controlled to produce a relative motion, the clipping block is transferred from the slip space to the yield space, and at the time, the convex clipping tooth engaged with the outer thread of the screw is not limited by the one-way engagement positioning; when the convex clipping tooth is engaged with the outer thread of the screw and the clipping block in the slip space forms the one-way engagement positioning, the screw is engaged with the convex clipping tooth in one way only, so that the second clamp part can clamp the first clamp part for a first time by a pushing method, and the operating part is operated after the pushing to drive the second clamp part and the first clamp part to produce a second time clamping and tightening; when the clipping block is in the yield space, and the convex clipping tooth is engaged with the outer thread of the screw, the clipping tooth is not limited by the one-way engagement positioning, but can control the clipping block to separate from the screw, so as to allow the second clamp part and the first clamp part to be quickly and movably opened.

The present disclosure provides a broad scope of applicability, and allows an object to be quickly and tightly clamped and easily released with great ease and convenience.

### BRIEF DESCRIPTION OF THE DRAWINGS

FIG. 1 is a perspective view of the present disclosure;

FIG. 2 is an exploded view of the present disclosure;

FIG. 3 is an exploded view of a buckle device of the present disclosure;

FIG. 4 is a planar view of the present disclosure;

FIG. 5 is another planar view of the present disclosure;

FIG. 6 is a cross-sectional view of Section A-A of FIG. 4;

FIG. 7 is a cross-sectional view of Section B-B of FIG. 5;

FIG. 8 is a cross-sectional view of Section C-C of FIG. 5;

FIG. 9 is a cross-sectional view showing a clamping action of the present disclosure;

FIG. 10 is a cross-sectional view showing another clamping action of the present disclosure;

FIG. 11 is a cross-sectional view showing a further clamping action of the present disclosure;

FIG. 12 is a cross-sectional view showing a clamping and tightening action of securing a second clamp part with a first clamp part of the present disclosure;

FIG. 13 is a cross-sectional view showing an opening action the present disclosure;

FIG. 14 is a cross-sectional view showing another opening action the present disclosure;

FIG. 15 is a cross-sectional view showing a further opening action the present disclosure;

FIG. 16 is a schematic view of the present disclosure applied to a bicycle repair stand; and

FIG. 17 is a cross-sectional view of a related-art clamp.

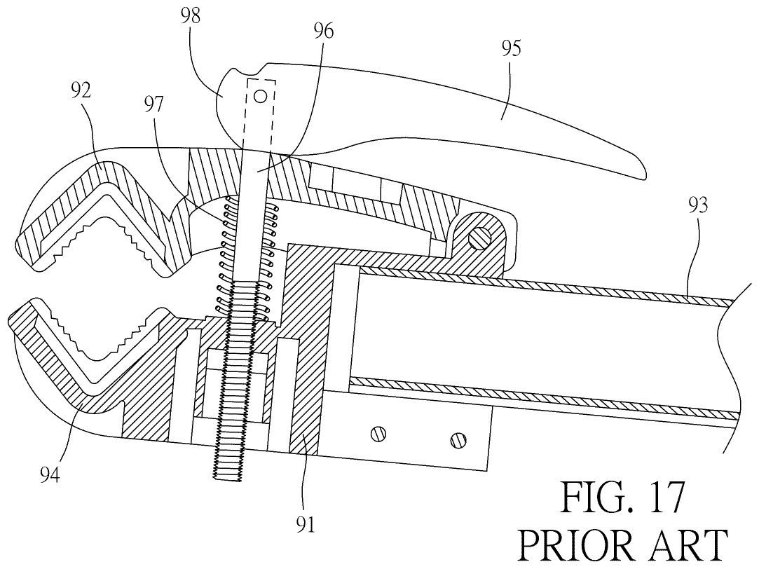

### DETAILED DESCRIPTION OF THE PREFERRED EMBODIMENTS

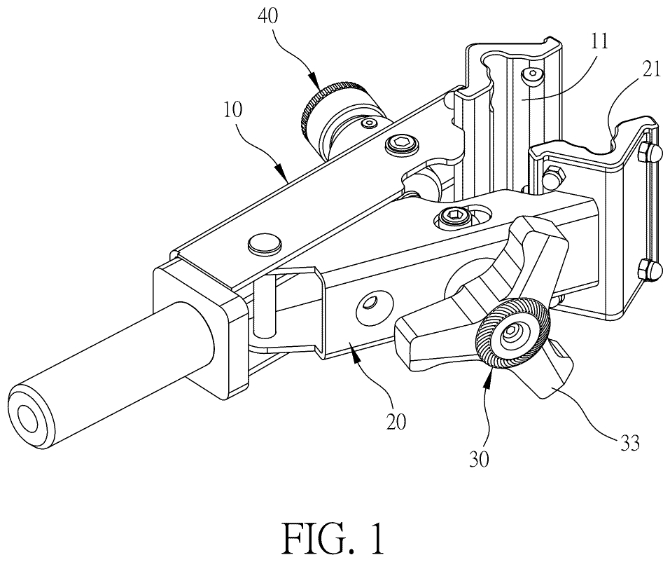

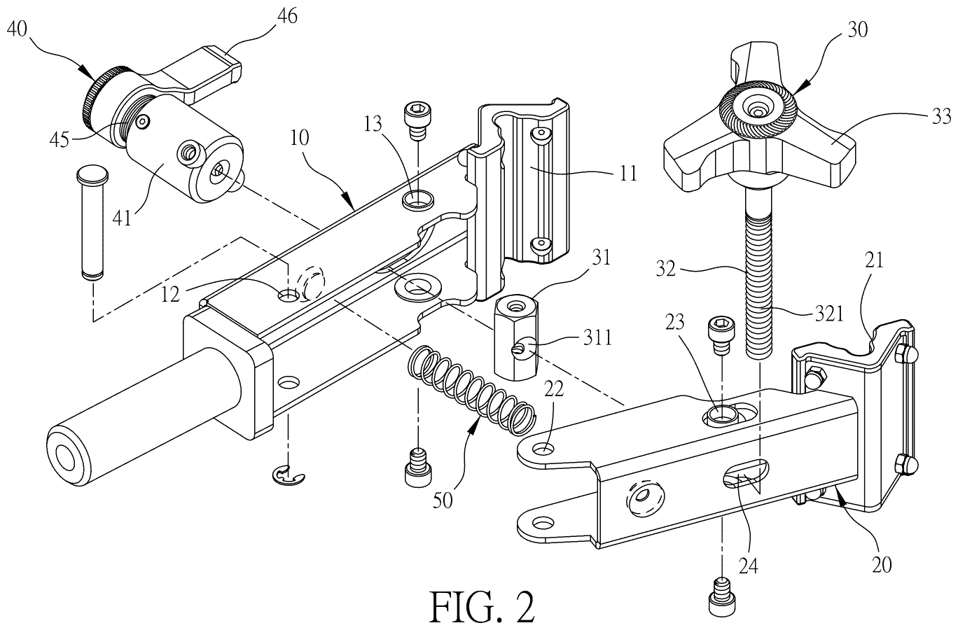

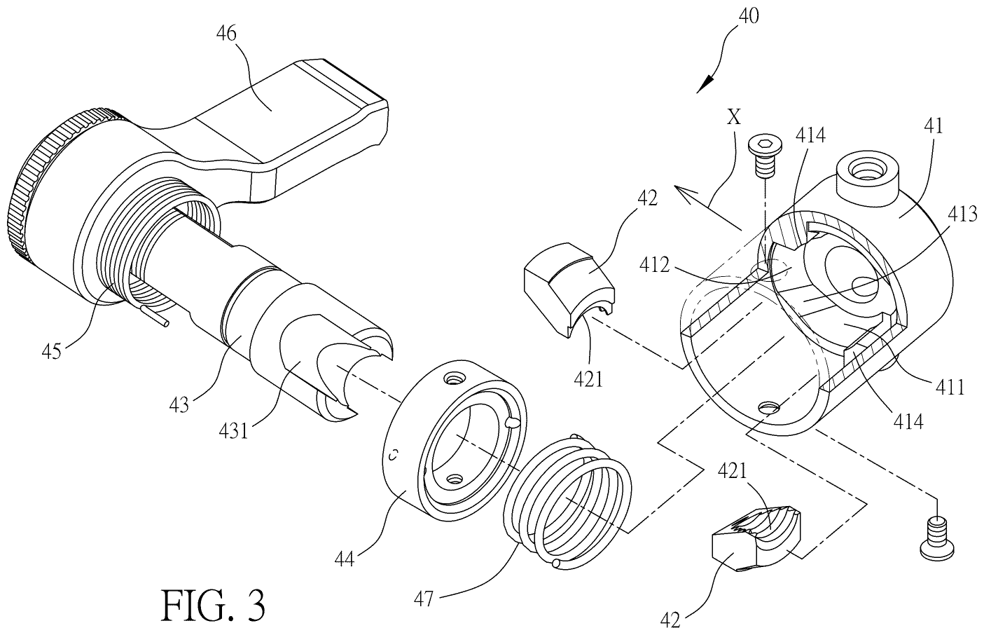

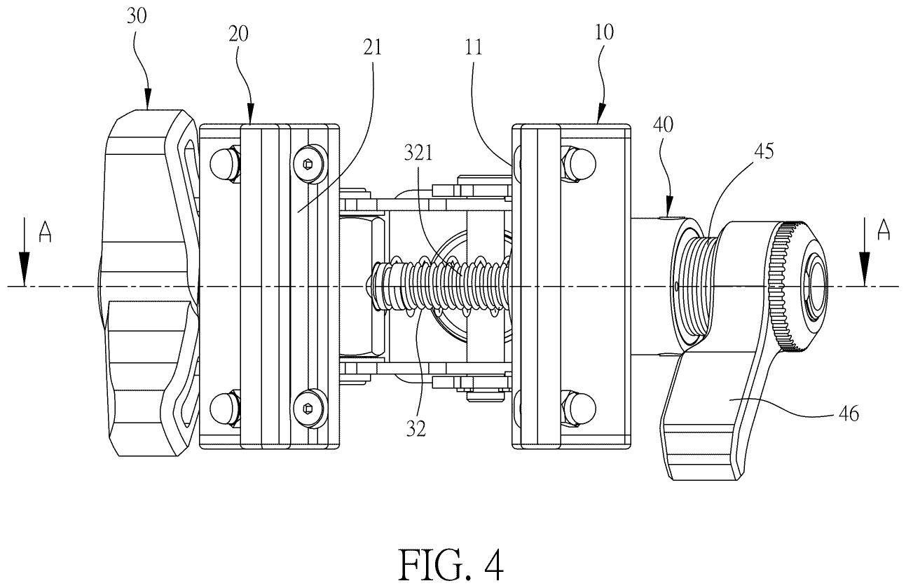

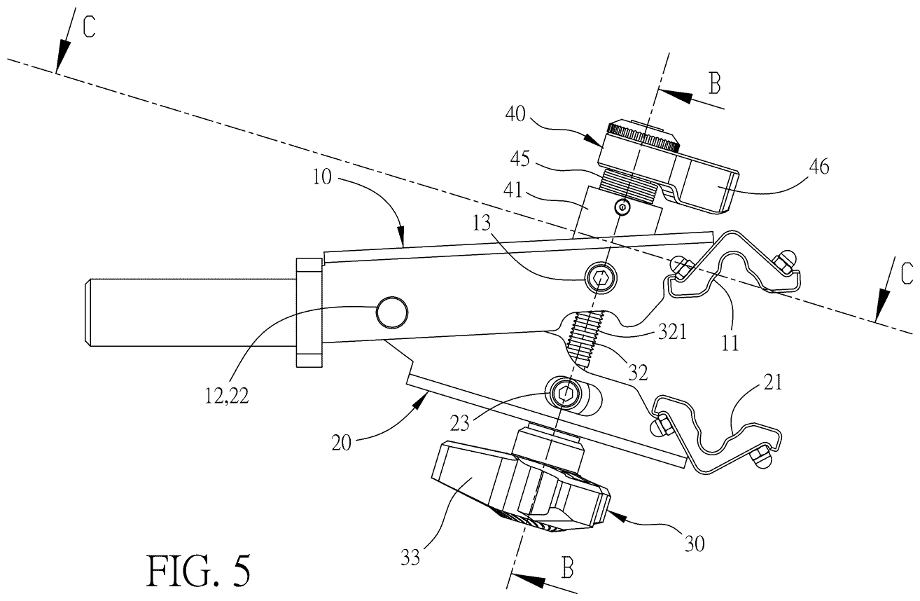

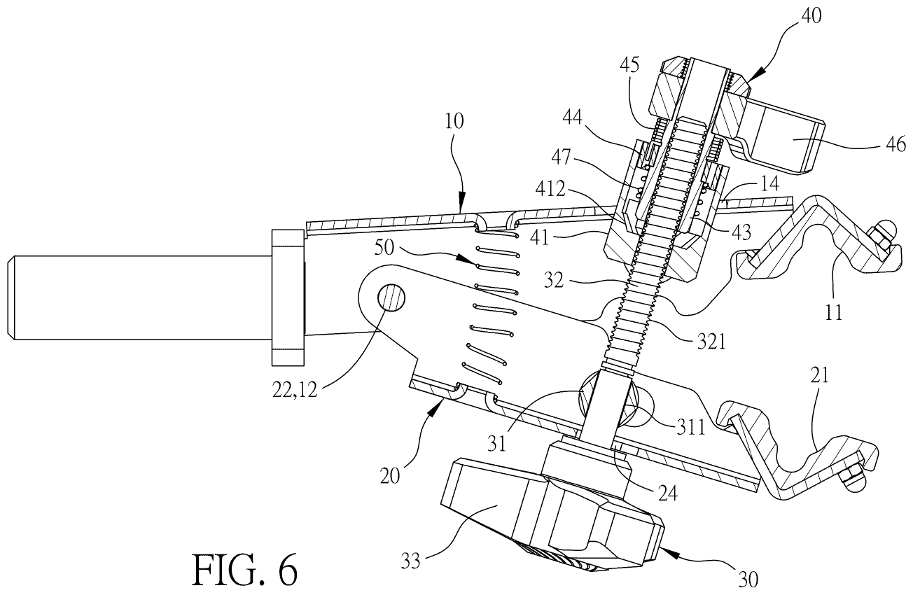

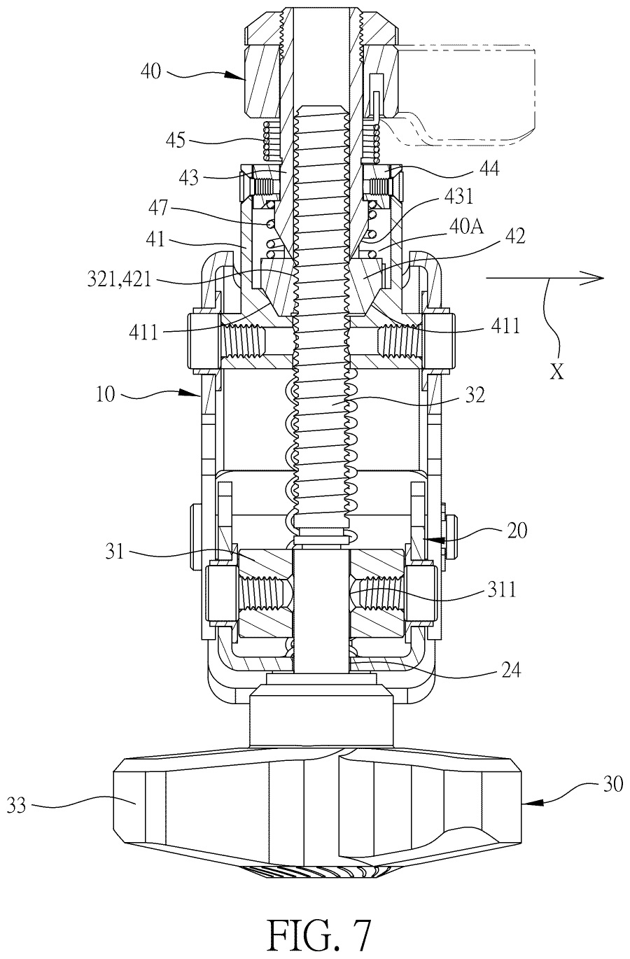

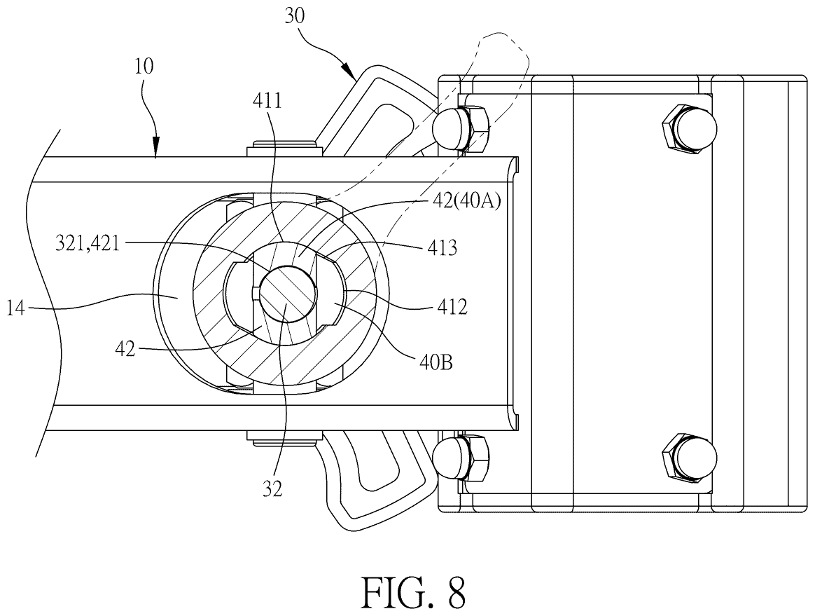

With reference to FIGS. 1 to 8 for a quick clamp of the present disclosure, the quick clamp includes a first clamp part 10, a second clamp part 20, a tightening device 30, a buckle device 40 and an elastic means 50.

The first clamp part 10 has an end combined and fixed to a position and another end having a first clamping part 11, the first clamp part 10 away from the first clamping part 11 has a first pivot part 12, and the first clamp part 10 has a second pivot part 13 disposed near the first clamping part 11 and an assembly hole 14 formed on an outer side of the first clamping part 11.

The second clamp part 20 has end combined and fixed to the corresponding first clamp part 10 and another end having a second clamping part 21 corresponding to the first clamping part 11, an opening or clamping action (the opening or clamping action of the embodiment is a fan-shaped or linear displacement) can be performed between the second clamp part 20 and the first clamp part 10, and the second clamp part 20 away from the second clamping part 21 has a third pivot part 22 pivoted to the first pivot part 12, such that an end of the second clamp part 20 is combined and fixed to the first clamp part, the second clamp part 20 has a fourth pivot part 23 disposed between the second clamping part 21 and the third pivot part 22 and has a first through hole 24 formed on an outer side of the second clamp part 20.

The tightening device 30 includes a cylindrical part 31, a screw 32 and an operating part 33, the cylindrical part 31 is disposed inside the second clamp part 20 and pivoted to the fourth pivot part 23, the cylindrical part 31 has a second through hole 311, the screw 32 passes through the second clamp part 20 and the first clamp part 10 and through the first through hole 24 of the second clamp part 20 and the second through hole 311 of the cylindrical part 31, the operating part 33 is installed on an outer side of the second clamp part 20 and combined with the screw 32, the operating part 33 can be rotated to link the screw 32 to rotate, and the screw 32 has an outer thread 321.

The buckle device 40 is installed onto the first clamp part 10 and provided for passing the screw 32, the buckle device 40 includes a cylinder 41, at least one clipping block 42, a control rod 43, a limiter 44, a position-restoring means 45 and a pushback means 47, and the buckle device 40 away from the screw 32 has an outer diameter X.

An end of the control rod 43 is provided with at least one titled buckle slot 431.

The cylinder 41 is sheathed on the control rod 43, a first position of the cylinder 41 is provided with at least one first limit slot 411 tilted with respect to the control rod 43, such that a slip space 40A with an increasing larger outer diameter is formed between the titled buckle slot 431 and the titled first limit slot 411, and at this time, the inclined surface of the buckle slot 431 and the inclined surface of the first limit slot 411 are parallel to each other, a second position of the control rod 43 corresponding to the cylinder 41 is provided with at least one second limit slot 412, such that a yield space 40B an increasing larger outer diameter is formed between the buckle slot 431 and the second limit slot 412 and has an outer diameter X greater than the slip space 40A, the second limit slot 412 has a depth greater than the depth of the first limit slot 411, a guide slope 413 is formed between the first limit slot 411 and the second limit slot 412, the control rod 43 outside the assembly hole 14 is combined with a rotating handle 46, and driven by the rotating handle 46 to drive the control rod 43 to rotate, so as to achieve the effect of controlling the cylinder 41 and the control rod 43 to produce a relative motion, and an end of the first limit slot 411 and an end of the second limit slot 412 are formed with a stop block 414 respectively.

An inner side of the clipping block 42 is provided with a convex clipping tooth 421, the clipping block 42 is disposed at the buckle slot 431 and the peripheral side of the screw 32, the clipping block 42 is normally situated between the first limit slot 411 and the buckle slot 431 of the cylinder 41, the convex clipping tooth 421 is engaged with the outer thread 321 of the screw 32 to form a one-way engagement positioning to limit the screw 32 to only move in one direction. When the cylinder 41 and the control rod 43 are controlled to produce a relative motion, the clipping block 42 is transferred from the slip space 40A to the yield space 40B. At this time, the convex clipping tooth 421 is engaged with the outer thread 321 of the screw 32, and thus not limited by the one-way engagement positioning.

The limiter 44 is a ring body mounted on the cylinder 41 for limiting the position of the control rod 43.

The position-restoring means 45 is installed between the rotating handle 46 and cylinder 41 for making the rotating handle 46 and the control rod 43 to have a position restoring elasticity, the position-restoring means 45 is a torsion spring with an end fixed to the limiter 44 and another end fixed to the rotating handle 46.

The pushback means 47 is provided for pushing the clipping block 42 normally situated in the slip space 40A towards the screw 32, and the pushback means 47 is installed between the limiter 44 and the clipping block 42.

The elastic means 50 is installed between the first clamp part 10 and the second clamp part 20, such that a tension elasticity exists between the second clamp part 20 and the first clamp part 10, the elastic means 50 is a compression spring with an end abutting the first clamp part 10 and another end abutting the second clamp part 20.

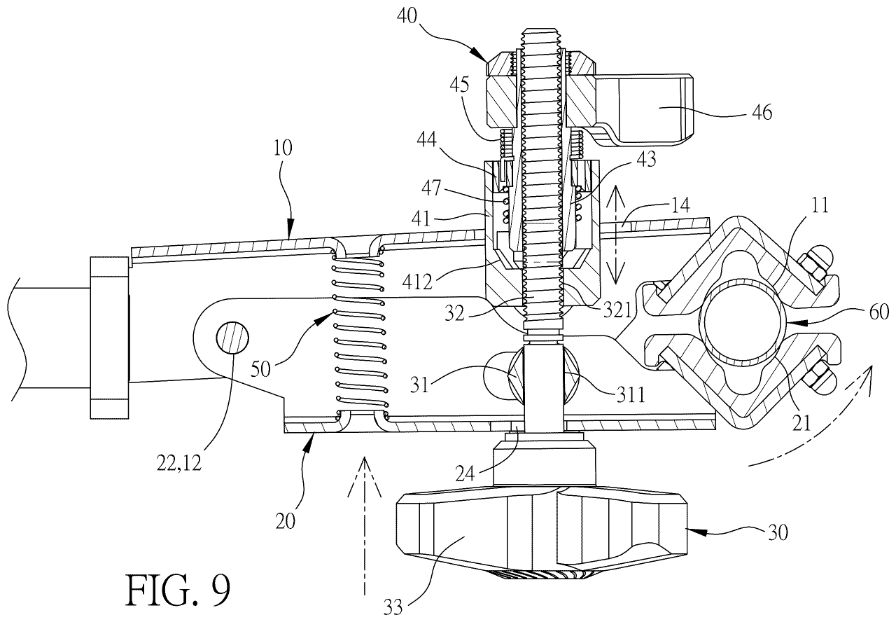

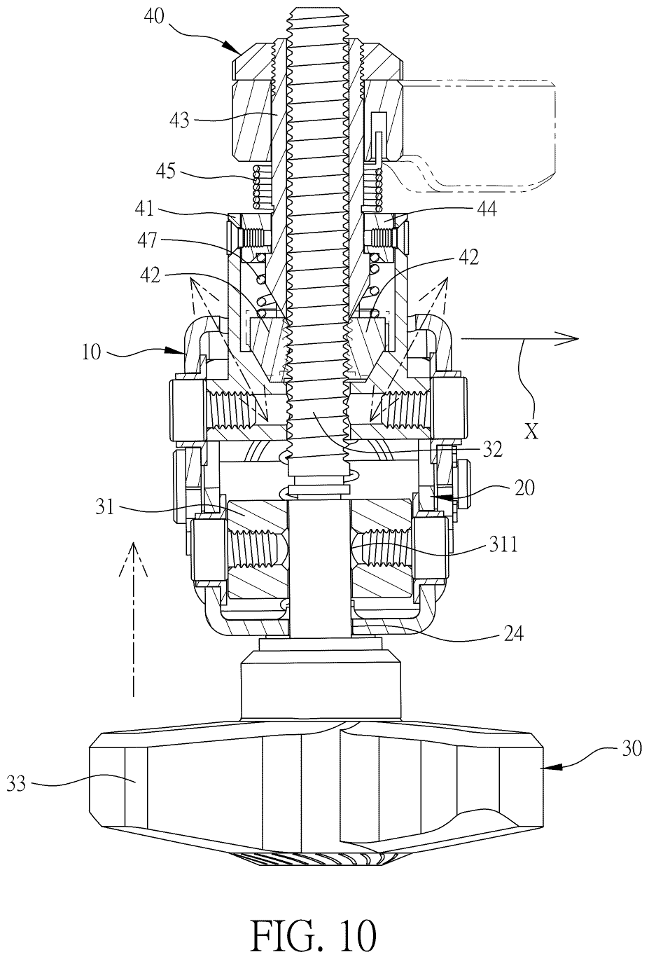

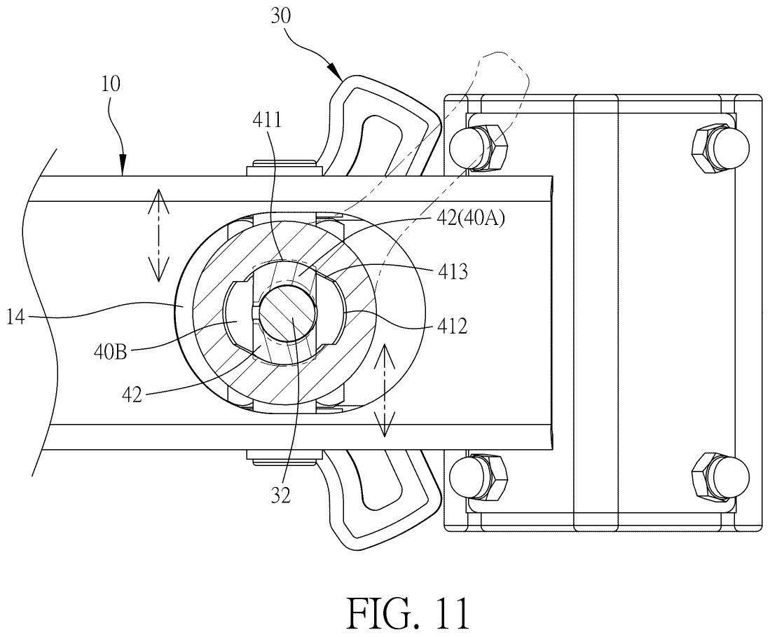

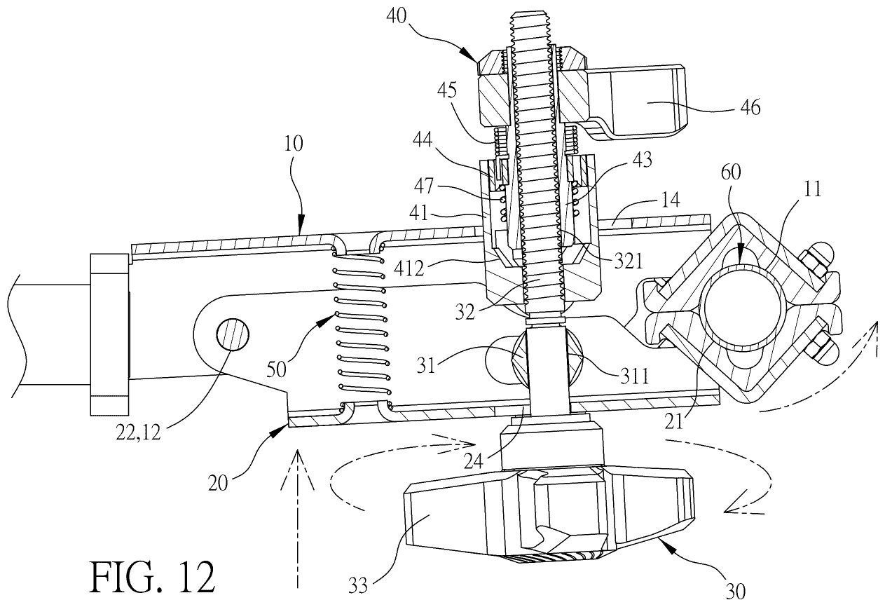

During use as shown in FIGS. 9 to 11, the clamped object 60 is placed at the first clamping part 11, the second clamp part 20 is pushed with the first clamp part 10 to perform a clamping action, and while the second clamp part 20 is being pushed, the screw 32 is pushed altogether. At this time, the convex clipping tooth 421 is engaged with the outer thread 321 of the screw 32, and the clipping block 42 in the slip space 40A forms a one-way engagement positioning to limit the screw 32 to be latched with the convex clipping tooth 421 on only one direction, and the outer side of the clipping block 42 and the corresponding inclined surface of the first limit slot 411 can be used to make the clipping block 42 to jump diagonally up and down, the convex clipping tooth 421 of the clipping block 42 gradually changes its engagement with the outer thread 321 of the screw 32 step by step, until the second clamping part 21 and the first clamping part 11 clamp a lamped object 60 to define a first-time clamping. To enhance the clamping force of the clamped object 60 clamped by the second clamping part 21 and the first clamping part 11, under the first clamping state as shown in FIG. 12, the operating part 33 is rotated to link the screw 32 to rotate, and the screw 32 performs a screwing action relative to the clipping block 42 to drive the second clamp part 20 and the first clamp part 10 to produce a stronger clamping force and a second-time clamping and tightening, so as to securely clamp the clamped object 60.

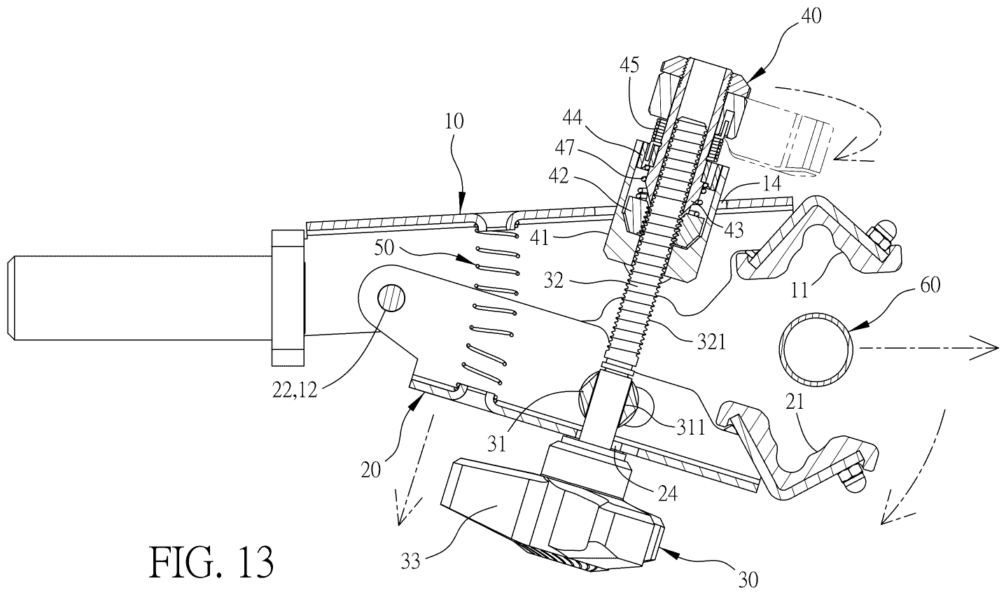

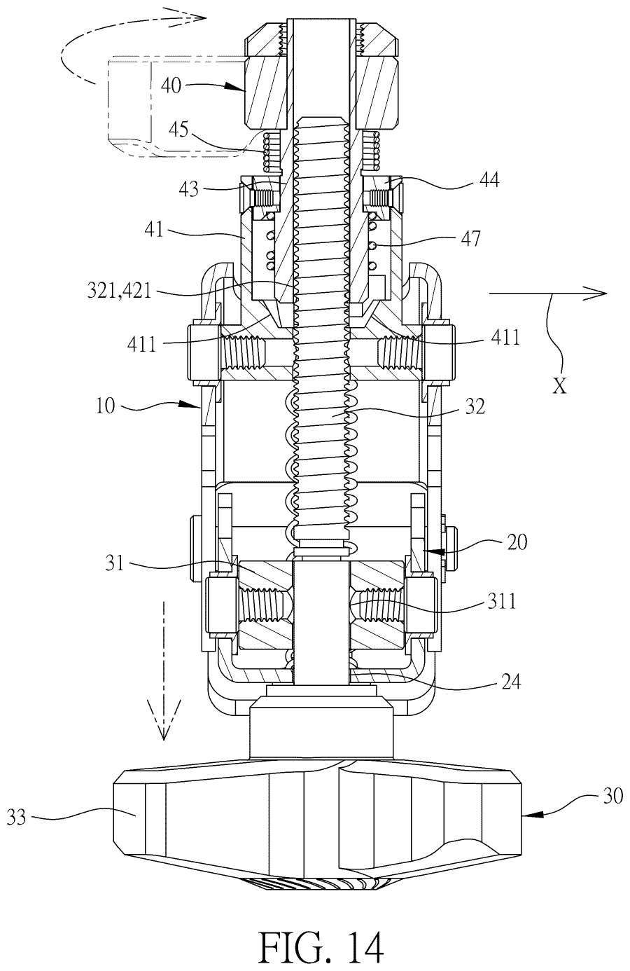

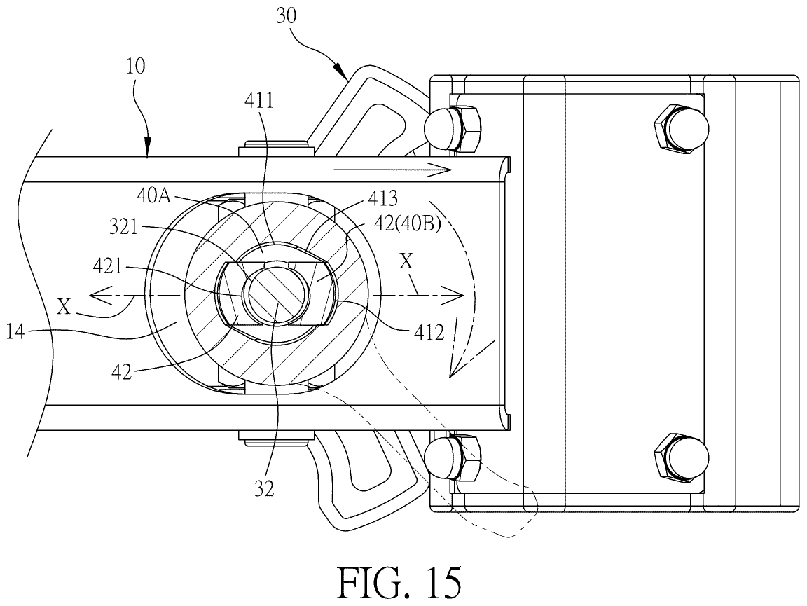

When it is necessary to open the second clamp part 20 and the first clamp part 10 as shown in FIGS. 13 to 15, the rotating handle 46 of the buckle device 40 is rotate to drive the control rod 43 to rotate, the control rod 43 drives the clipping block 42 to slide from the position of the first limit slot 411 to the position of the second limit slot 412 through the guide slope 413, and at this time, the clipping block 42 is in the yield space 40B, the convex clipping tooth 421 is engaged with the outer thread 321 of the screw 32 without being limited by the one-way engagement positioning, the clipping block 42 can be controlled to separate from the screw 32, the convex clipping tooth 421 of the clipping block 42 is separated from the outer thread 321 of the screw 32, so as to quickly and movably open the second clamp part 20 and the first clamp part 10, and the elastic means 50 can be used to automatically open the first clamp part 10 and the second clamp part 20 to release the clamped object 60. When the rotating handle 46 of the buckle device 40 is released, the position-restoring means 45 will drive the rotating handle and the control rod 43 to restore their original positions, and the clipping block 42 will slide back to the position of the first limit slot 411 again.

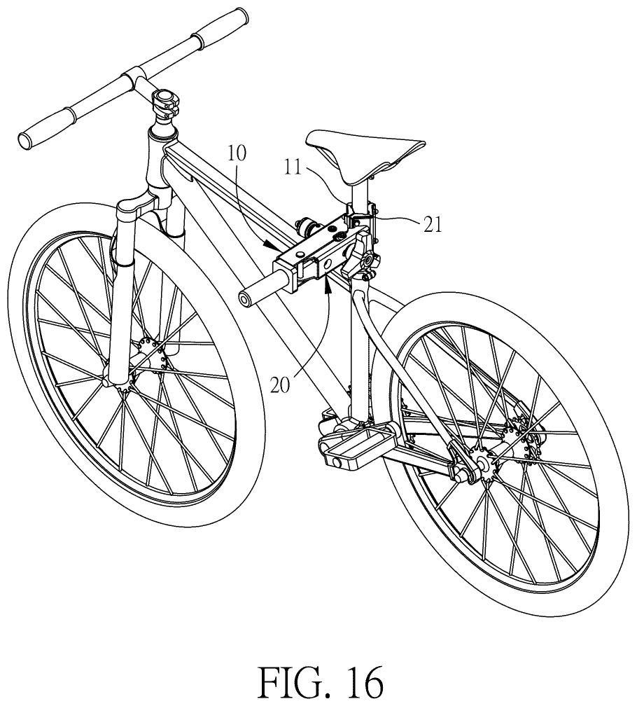

In FIG. 16, the quick clamp is applied to a bicycle maintenance stand, and the second clamping part 21 of the first clamp part 10 and first clamping part 11 of the second clamp part 20 clamp the bicycle stand (which is the clamped object).

With the structure of the aforementioned embodiment, the present disclosure has the following advantages:

The quick clamp of the present disclosure has a wide scope of applicability and adopts the convex clipping tooth 421 of at least one clipping block 42 to operate with the outer thread 321 of the screw 32 to form a strong one-way engagement positioning, so as to provide a quick clamping action and a convenient opening action during use, and facilitate users to open the clamps for securing an object to be clamped and securely clamping the clamped object 60, thus featuring extreme convenience and excellent operability of use.

What is claimed is:

1. A quick clamp, comprising:
a first clamp part, with an end combined and fixed to a position and another end having a first clamping part;
a second clamp part, with an end combined and fixed to a position corresponding to the first clamp part and another end having a second clamping part, which corresponds to the first clamping part, and can be opened or clamped relative to the first clamp part;
a tightening device, comprising a screw and an operating part, the screw passing through the second clamp part and the first clamp part, and the operating part being installed on an outer side of the second clamp part; and
a buckle device, installed onto the first clamp part and provided for passing the screw, comprising a cylinder, at least one clipping block, a control rod and a pushback means, and the buckle device has an outer diameter away from the screw;
wherein, an end of the control rod is provided with at least one tilted buckle slot;
the cylinder is sheathed on the control rod;
a titled first limit slot is formed on the control rod and at a position corresponding to the cylinder to create a slip space with an increasingly larger outer diameter between the titled buckle slot and the titled first limit slot, and at this time an inclined surface of the buckle slot corresponding to an inclined surface of the first limit slot, and the control rod having a second limit slot configured to be corresponsive to the cylinder second, such that a yield space formed between the buckle slot and the second limit slot has an outer diameter greater than the slip space; wherein
the clipping block having a convex clipping tooth disposed on an inner side thereof, the clipping block being disposed at the buckle slot and a peripheral side of the screw, the at least one clipping block is normally situated between the first limit slot and the buckle slot of the cylinder, and the convex clipping tooth is engaged with an outer thread of the screw to form a one-way engagement positioning for limiting the screw to only move in one direction;
the pushback means is provided for pushing the screw block normally situated in the slip space towards the screw;
when the cylinder and the control rod are controlled to produce a relative motion, the clipping block is transferred from the slip space to the yield space, and at the time, the convex clipping tooth engaged with the outer thread of the screw is not limited by the one-way engagement positioning;
when the convex clipping tooth is engaged with the outer thread of the screw and the clipping block in the slip space forms the one-way engagement positioning, the screw is engaged with the convex clipping tooth in one way only, so that the second clamp part can clamp the first clamp part for a first time by a pushing method, and the operating part is operated after the pushing to drive the second clamp part and the first clamp part to produce a second time clamping and tightening;
when the clipping block is in the yield space, and the convex clipping tooth is engaged with the outer thread of the screw, the clipping tooth is not limited by the one-way engagement positioning, but can control the clipping block to separate from the screw, so as to allow the second clamp part and the first clamp part to be quickly and movably opened.

2. The quick clamp according to claim 1, wherein the second limit slot has a depth greater than the depth of the first limit slot, and a guide slope is formed between the first limit slot and the second limit slot.

3. The quick clamp according to claim 1, wherein the buckle device further comprises a limiter and a position-restoring means, the first clamp part has a second pivot part disposed near the first clamping part and an assembly hole formed on an outer side of the first clamp part, the control rod outside the assembly hole is combined with a rotating handle, and driven by the rotating handle to rotate, so as to achieve the effect of controlling the cylinder and the control rod to produce the relative motion, the limiter is installed onto the cylinder and provided for limiting the position of the control rod, the position-restoring means is installed between the rotating handle and the cylinder and provided for making the rotating handle and the control rod to have a position restoring elasticity, and the pushback means is installed between the limiter and the clipping block.

4. The quick clamp according to claim 3, wherein the position-restoring means is a torsion spring with an end fixed to the limiter and another end fixed to the rotating handle.

5. The quick clamp according to claim 1, wherein the first clamp part has a first pivot part disposed away from the first clamping part, the second clamp part has a third pivot part disposed away from the second clamping part, and the third pivot part and the first pivot part are pivoted.

6. The quick clamp according to claim 1, wherein the first clamp part has a second pivot part disposed adjacent to the first clamping part and an assembly hole formed on an outer side of the first clamp part and provided for sheathing the cylinder of the buckle device, and the second pivot part is provided for being pivoted to the cylinder of the buckle device.

7. The quick clamp according to claim 1, wherein the second clamp part comprises a fourth pivot part and a first through hole formed on an outer side of the second clamp part, the tightening device further comprises a cylindrical part disposed in the second clamp part and pivoted to the fourth pivot part, the cylindrical part comprises a second through hole, the screw passes through the first through hole and the second through hole, and the operating part can be rotated to link the screw to rotate.

8. The quick clamp according to claim 1, further comprising an elastic means installed between the first clamp part and the second clamp part, so that a tension elasticity exists between the second clamp part and the first clamp part, and the elastic means is a compression spring.

9. The quick clamp according to claim 1, wherein the buckle slot and the first limit slot have inclined surfaces respectively parallel to one another.

10. The quick clamp according to claim 1, wherein the first limit slot and the second limit slot have a stop block at an end thereof respectively.
